(19) United States
(12) Patent Application Publication
(10) Pub. No.: US 2018/0310525 A1
(43) Pub. Date: Nov. 1, 2018

(54) SYSTEMS AND METHODS FOR WIRELESSLY PROGRAMMING AND CONTROLLING ANIMAL TRAINING SYSTEMS

(71) Applicant: Perimeter Technologies, Inc., Reading, PA (US)

(72) Inventors: Blaine Bacher, West Chester, OH (US); Nathan C Keller, Reading, PA (US); Kahl Anderson Orr, Wernersville, PA (US)

(21) Appl. No.: 15/959,674

(22) Filed: Apr. 23, 2018

Related U.S. Application Data
(60) Provisional application No. 62/490,815, filed on Apr. 27, 2017.

(51) Int. Cl. A01K 15/02; G08C 17/02; A01K 27/00

(52) U.S. Cl. CPC A01K 15/021; G08C 17/02; G08C 2201/20; G08C 2201/93; A01K 27/009

(57) ABSTRACT

Devices and methods for wirelessly controlling and programming animal training systems, including wireless transmitters/receivers and an animal stimulus receiver provided on an animal collar.

### FIELD OF THE INVENTION

The present invention relates generally to devices and methods for wirelessly controlling and programming animal training systems, including, for example, system components such as wireless transmitters/receivers and an animal stimulus receiver provided on an animal collar.

### BACKGROUND

Many animal owners concerned about the safety and well-being of their pet employ animal training systems which include an animal collar fitted with an animal stimulus receiver to help train and deter the animal from behaviors that could place the animal in harm's way. Such animal stimulus receivers typically train the animal through the use of a control stimulus, such as electrical shocks, vibrational sensations, and audible sounds or alarms. While animal training systems can be effective when first purchased, improvements can arise that could enhance the performance of the animal training system if the animal stimulus receiver, and various other system components locally present at the site of the pet, could be programmed in the field to accept new program information. In addition, the customer interested in better understanding how the animal training system is interacting with their pet may like to have the ability to review the activity of the animal training system, as well as its current status. Accordingly, there is a need in the art for systems and methods for programming and controlling animal training systems and their various components.

### SUMMARY

In one of its aspects the present invention may provide a system for wirelessly programming and controlling an animal training system, such as one used in conjunction with an animal stimulus receiver provided on an animal collar. The system may include one or more animal training devices, provided at the site of an animal to be trained. The animal training device may include a communication unit configured to permit wireless communication therewith and a memory unit for storing program information therein. The animal training device may include one or more of an animal stimulus receiver, an outdoor transmitter, an indoor transmitter, and a stimulus receiver cradle. The animal stimulus receiver may be configured to deliver a stimulus to an animal. A server, such as a cloud-based server, may be provided for receiving and transmitting the program information for programming the animal training device. A dealer device may be disposed in communication with the server for transmitting the program information thereto, and a local communication device may be disposed in communication with the server for receiving the program information therefrom. The local communication device may include one or more of a customer device and a standalone unit.

The local communication device may be configured to wirelessly communicate with, and deliver the program information to, the memory unit of the animal training device. Additionally, the dealer device may be configured to wirelessly communicate with, and deliver the program information to, the memory unit of the animal training device. One or both of the local communication device and dealer device may include a portable electronic device, such as a cell phone or other device such as a tablet, which may wirelessly communicate with the animal training device. Wireless communication may occur at a frequency between 2 and 6 GHz. The memory unit may also be configured to store historical information on the operation of the animal training device, where the historical information may include one or more of stimulus durations, number of warnings issued to the animal, and stimulus magnitudes, for example. The communication unit may include a transceiver operable to transmit the historical information to the server via one or more of the local communication device and the dealer device.

In addition, in another of its aspects the present invention may provide a method for wirelessly programming and controlling an animal training device, including providing a server for receiving and transmitting program information for programming an animal training device; uploading the programming information to the server from a dealer device disposed in communication therewith; transmitting the program information from the server to a selected local communication device disposed in communication therewith; and, wirelessly transmitting the program information from one of the dealer device and selected local communication device to the animal training device to load the program information in the animal training device. The step of wirelessly transmitting the program information may include transmitting the program information from the selected local communication device to the animal training device, and the presence of available program information may be provided by sending an alert to the selected local communication device. The alert may be sent from the dealer device to the selected user device via the server. Alternatively, the local communication device may query the server to determine if program information is available for the selected local communication device.

Further, to ensure that the program information is delivered to the correct customer (and correct animal training device should the customer have more than one device), the step of uploading the program information may include identifying the selected customer (and animal training device) from a database of customers/training devices to associate the program information with the correct customer/training device. In addition, the method may include the step of determining if the selected local communication device is wirelessly connected to the animal training device. The program information may include data for specifying parameters for delivering the stimulus by the animal stimulus receiver, such as one or more of the stimulus duration, warning time, and stimulus magnitude, for example. The dealer device and/or the selected local communication device may be operated to 1) connect to the animal stimulus receiver, 2) check the battery level of the animal stimulus receiver, 3) check a history of the animal stimulus receiver, 4) activate a light on the animal stimulus receiver, 5) initialize animal training, and/or 6) check stimulus receiver cradle or outdoor transmitter.

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates a system for wirelessly controlling and programming animal training devices, such as an animal stimulus receiver, in accordance with the present invention;

FIGS. 2A-2G illustrate a flowchart of a method for wirelessly controlling and programming animal training devices, using for example, the system of FIG. 1, in which FIG. 2A illustrates steps for logging-in, registering, and authenticating a user, such as a dealer or customer; FIG. 2B illustrates steps that may be performed by the customer; FIG. 2C illustrates steps that may be performed by the dealer; FIGS. 2D-2G illustrate steps that may be performed by either the dealer or customer;

FIGS. 3A-3B illustrate a flowchart of a method for wirelessly controlling and programming animal training devices, including steps which may be performed in the cloud, such as by the server of FIG. 1, for example;

FIGS. 4A-4B illustrate a flowchart of a method for wirelessly controlling and programming animal training devices, including steps which may be performed by the local communication devices of FIG. 1, for example;

FIG. 5 illustrates a flowchart of communication between the cradle and collar of FIG. 1;

FIG. 6 illustrates exemplary programming and control information that may be programmed into animal training devices in accordance with the present invention; and

FIGS. 7A-7D schematically illustrate block diagrams showing a wireless transceiver in electrical communication with the system components of animal training devices, namely an animal stimulus receiver, indoor transmitter, outdoor transmitter, and cradle, respectively.

### DETAILED DESCRIPTION OF THE INVENTION

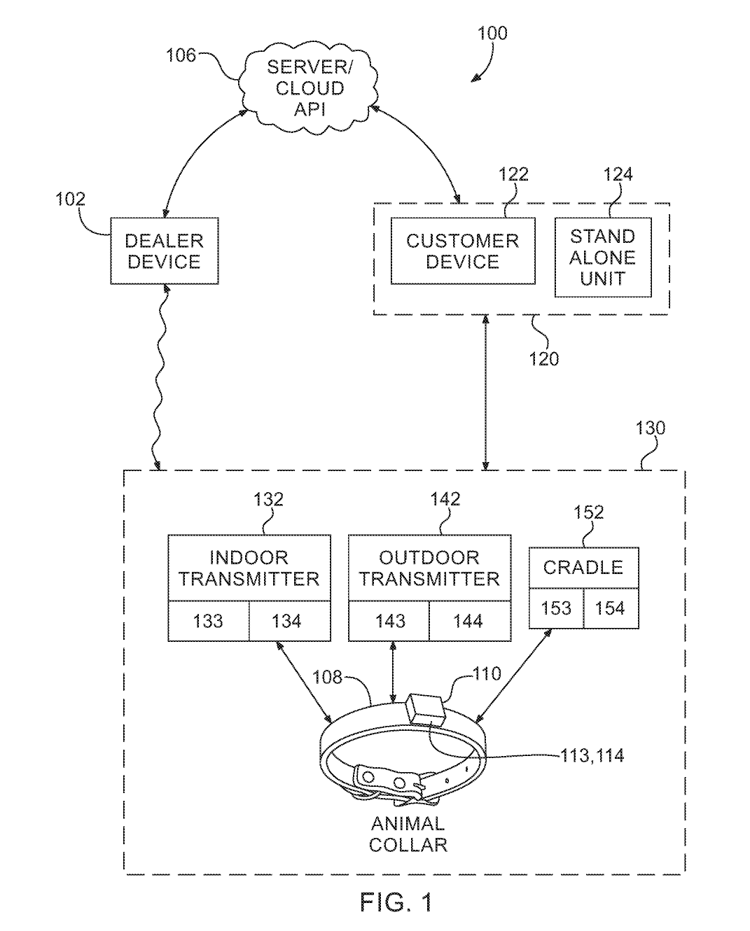

Referring now to the figures, wherein like elements are numbered alike throughout, FIG. 1 schematically illustrates an exemplary system 100 in accordance with the present invention for wirelessly controlling and programming animal training devices 130. Exemplary animal training devices 130 may include one or more of an animal stimulus receiver 110, which may be attached to an animal collar 108, an indoor transmitter 132, a cradle 152, and an outdoor transmitter 142, such as one operably connected to a buried antenna wire. A suitable exemplary cradle 152 which may be adapted for wireless communication is disclosed in U.S. Pat. No. 9,520,728, and a suitable exemplary outdoor transmitter 142 which may be adapted for wireless communication is disclosed in U.S. Pat. No. 5,682,839, the entire contents of which patents are incorporated herein by reference. A suitable exemplary indoor transmitter 132 which may be adapted for wireless communication is the RoomWizard™ Indoor Transmitter (Perimeter Technologies, Reading Pa.)

The system may also include a dealer device 102 and a server 106, and the server 106 may be located in the cloud and operated via an API (application program interface). In one of its typical modes of operation, the system 110 can allow for remote wireless programming of one or more of the animal training devices 130 by transmitting program information from the dealer device 102 to the server 106, and from the server 106 to a local communication device 120 disposed in wireless communication range with the animal training devices 130. Subsequently, the local communication device 120 can wirelessly transmit the program information to the animal training devices 130. The local communication device 120 can include a customer device 122 operated by the customer and/or a standalone unit 124 that can operate without customer intervention. Exemplary devices that can operate as a standalone unit 124 include “smart speaker” devices, such as Amazon Echo or Google Home.

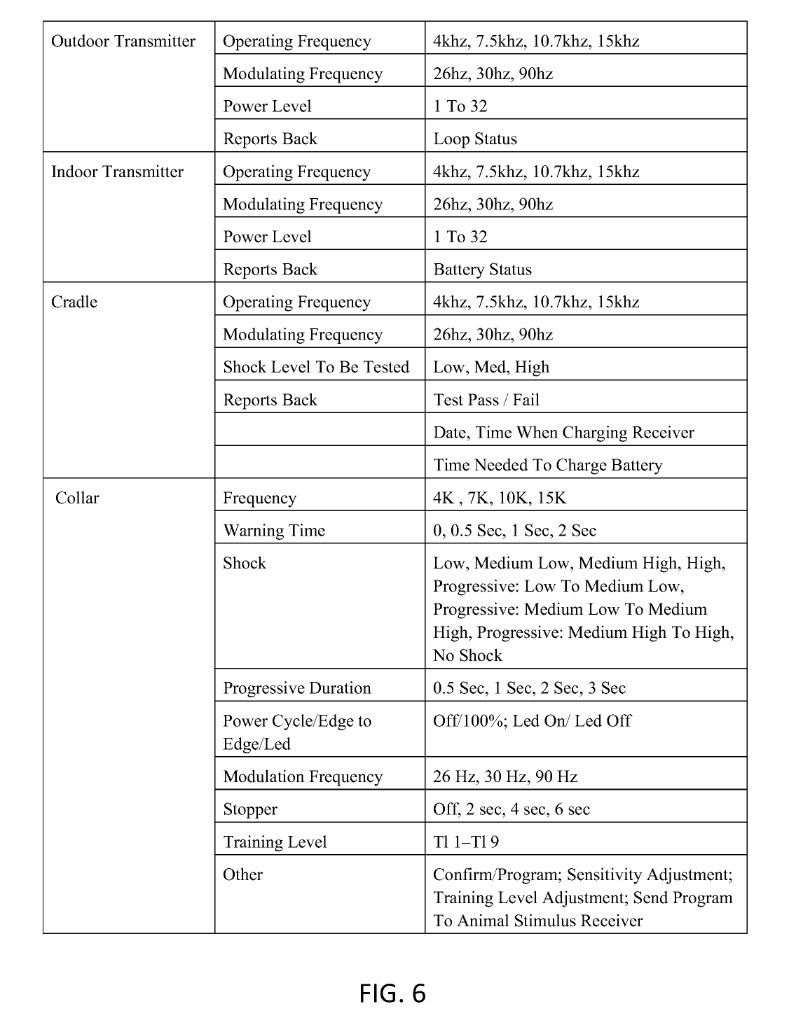

Additionally, information concerning the status and operation of the animal training devices 130 may be provided to the dealer for monitoring and analysis, and the monitoring and analysis may be the basis for dealer intervention, such as the creation of new program information to be loaded into the animal training devices 130. In this regard, the animal training devices 130 can provide information concerning their status and operation wirelessly to the local communication device 120, which can transmit such information to the server 106, which can transmit the information to the dealer device 102. The information concerning the operation of the animal training devices 130 may be accumulated over time, and the accumulated historical information may be used by the dealer in creation of new program information. Exemplary program information may include frequency of stimulus, stimulus (shock) level, warning time before application of stimulus, training level, progressive duration of the stimulus, modulation frequency of the wireless communication signal, and so forth, FIG. 6.

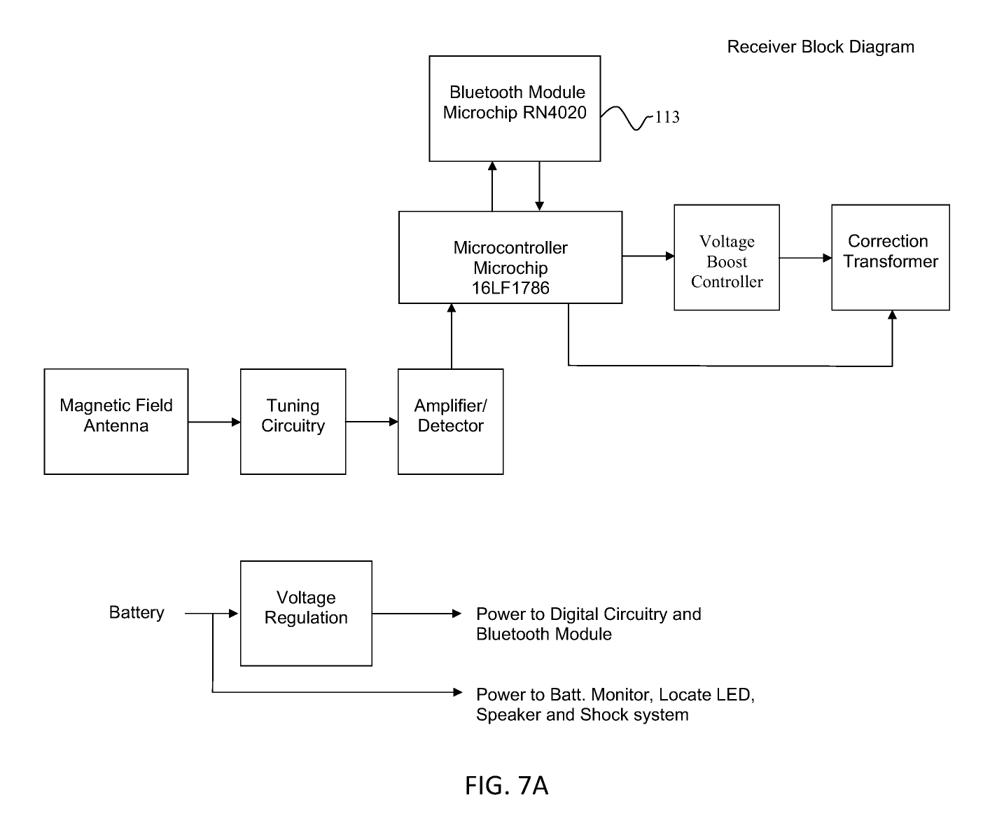

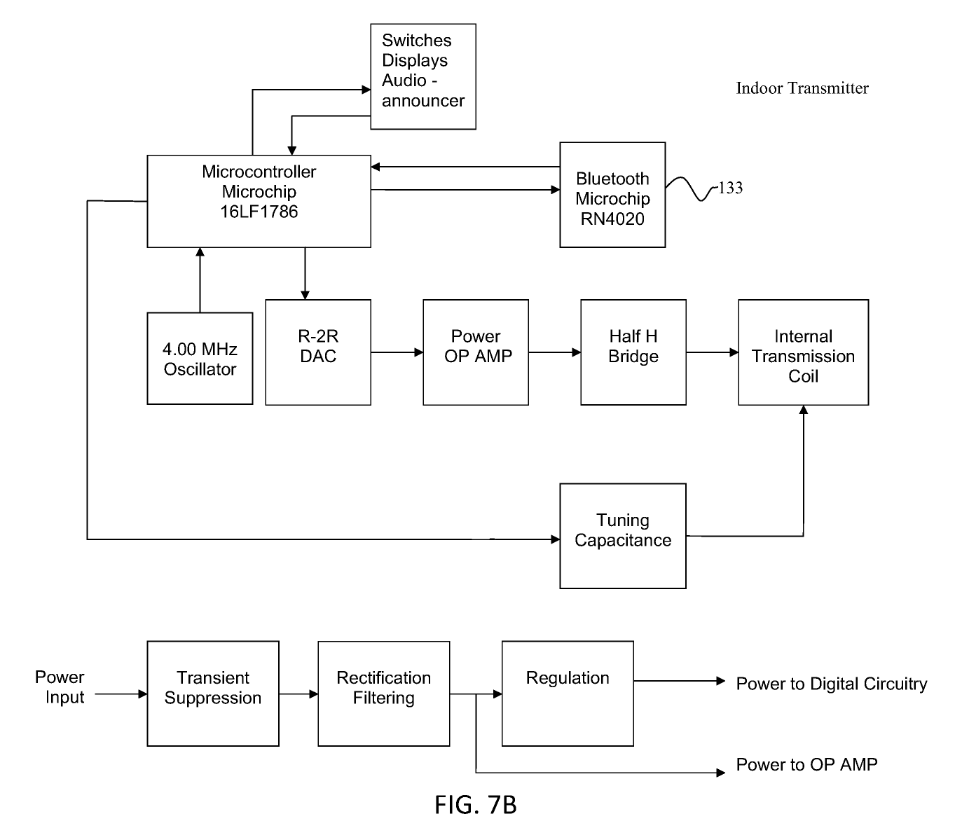

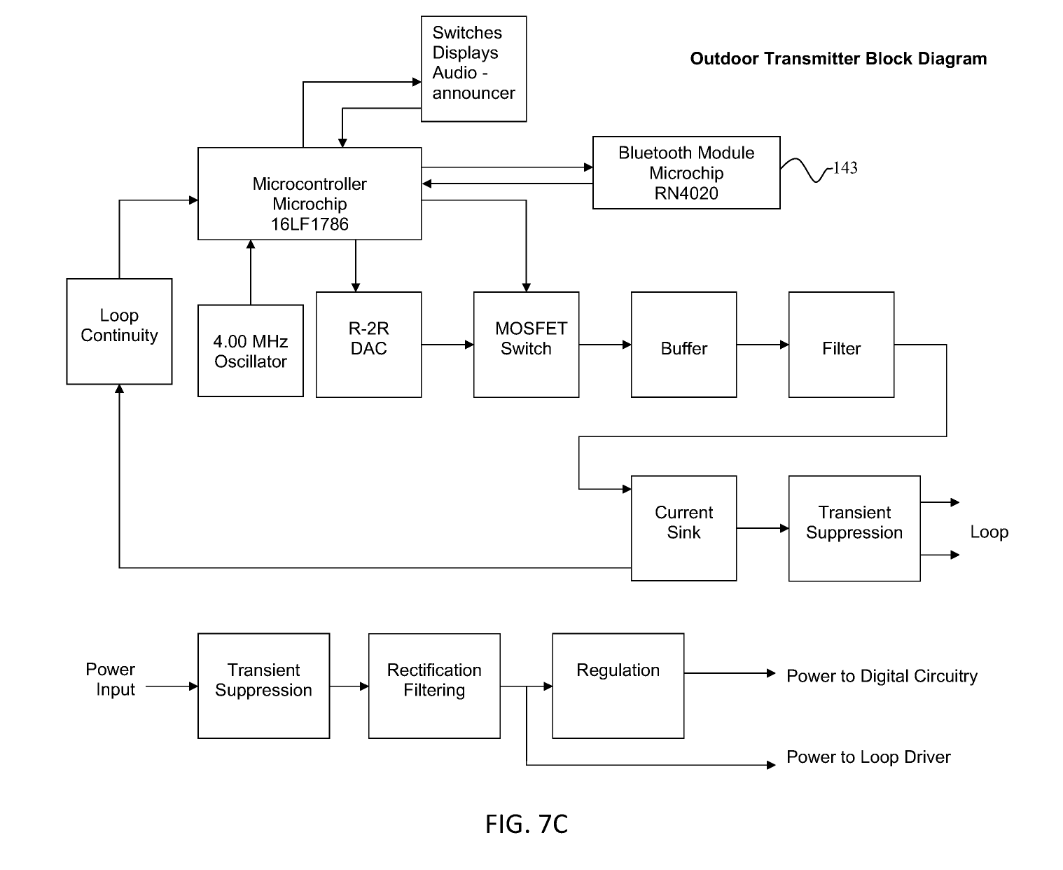

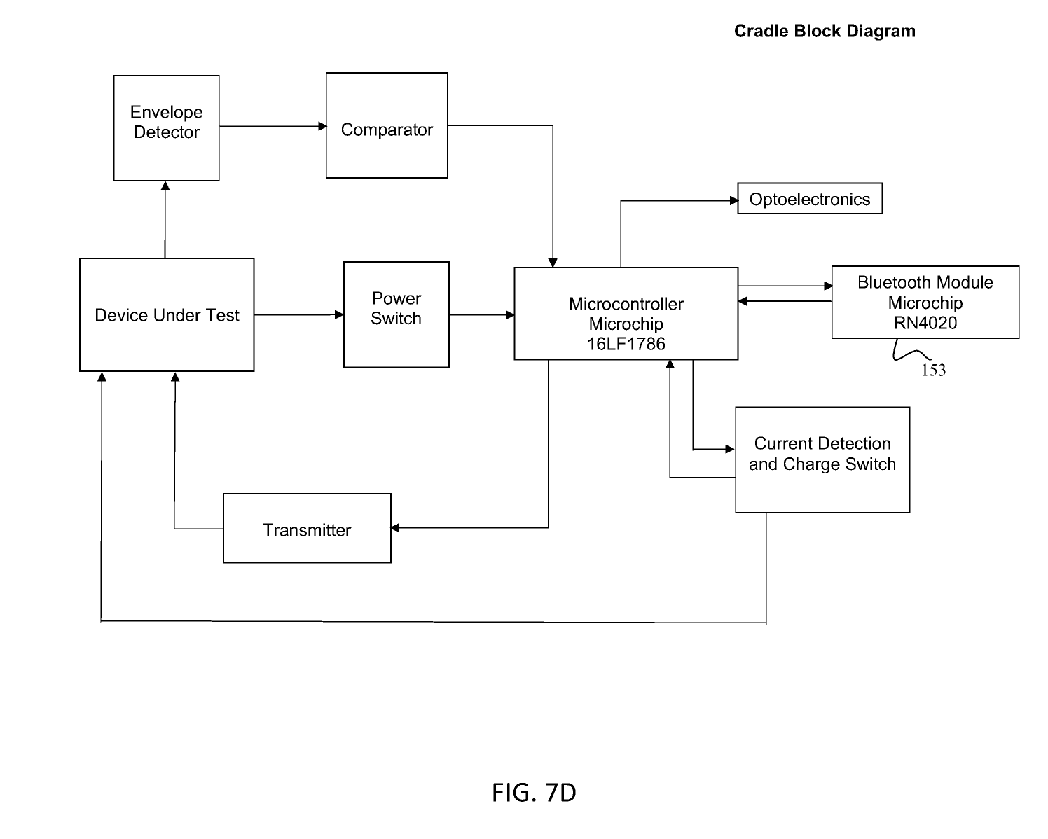

In further detail, one or more of the dealer device 102 and customer device 122 may be a portable electronic device, such as a cell phone. Wireless communication by the dealer device 102, local communication device 120, and animal training device 130 may be provided by any suitable wireless standard, such as Bluetooth technology, and may typically operate in a frequency range between 2-6 GHz, such as BlueTooth Module RN4020 from Microchip Technologies, Chandler, Ariz., USA. Typically, only the local communication device 120 is disposed sufficiently close to the animal training devices 130 to permit wireless communication. The dealer device 102 may most typically relay information to the animal training devices 130 through the server 106 and local communication device 120. However, in those instances where the dealer is on-site and within wireless communication range of the animal training devices 130, the dealer device 102 may wirelessly communicate with the animal training devices 130 in a manner similar to that of the local communication device 120. The animal training devices 130 may include various sub-units, such as a communication unit 113, 133, 143, 153 (FIGS. 7A-7D) configured to permit wireless communication with the device 130, and a memory unit 114, 134, 144, 154 for storing program information in the device 130, FIG. 1. Exemplary animal stimulus receivers 110 currently available that may be adapted for wireless communication for use with the present invention include EcoLite Receiver (Perimeter Technologies, Inc., Reading Pa.).

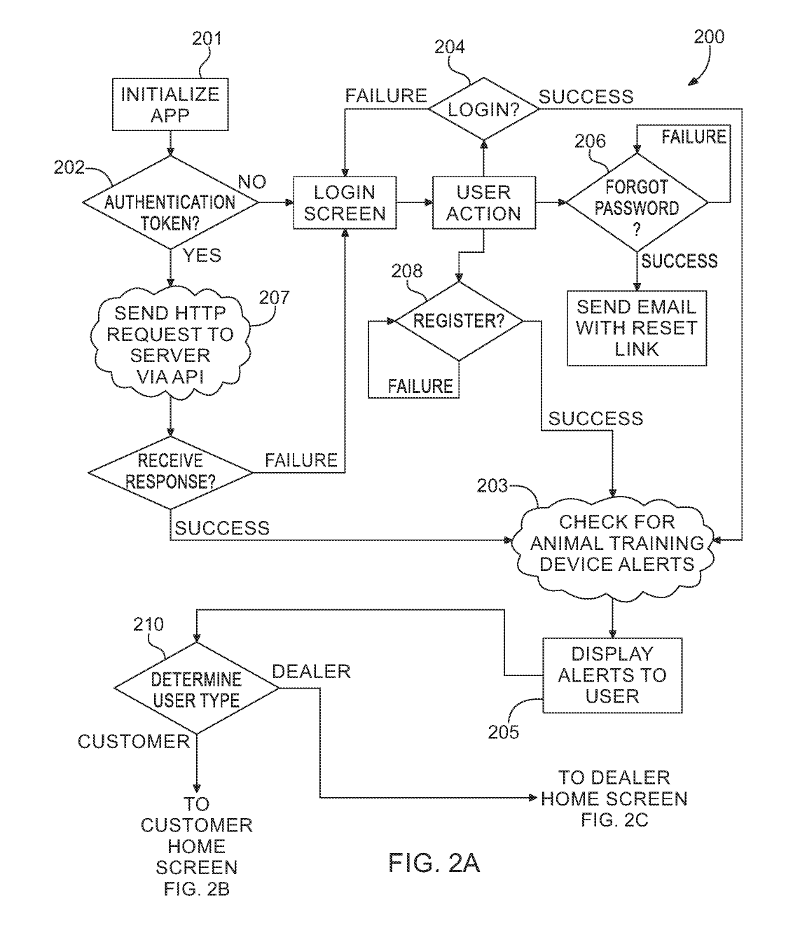

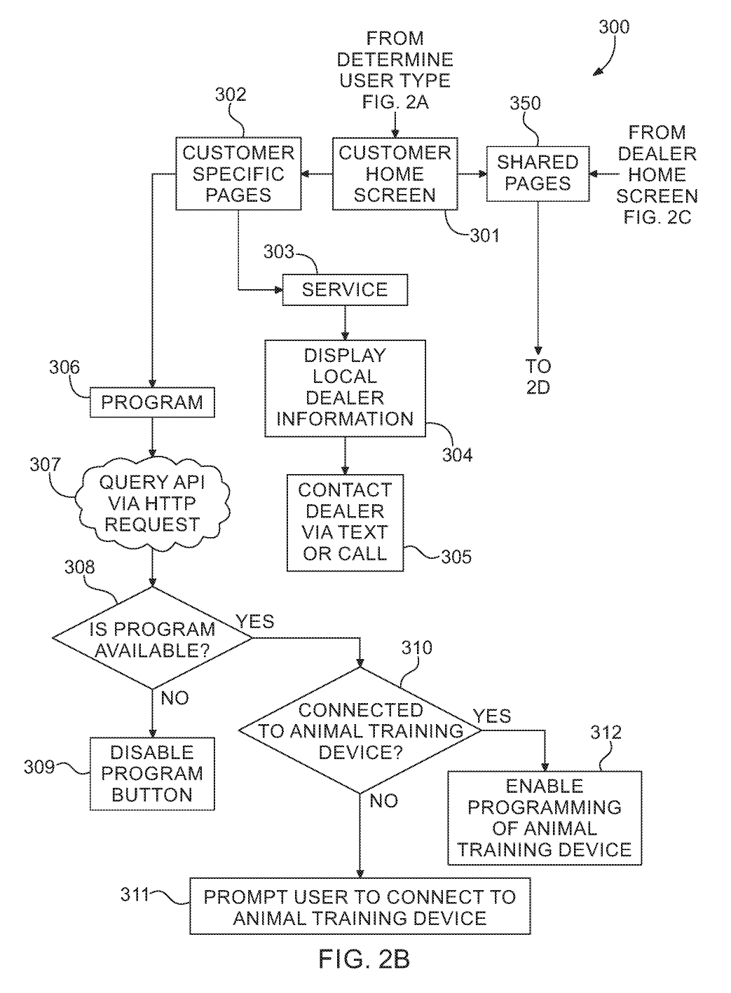

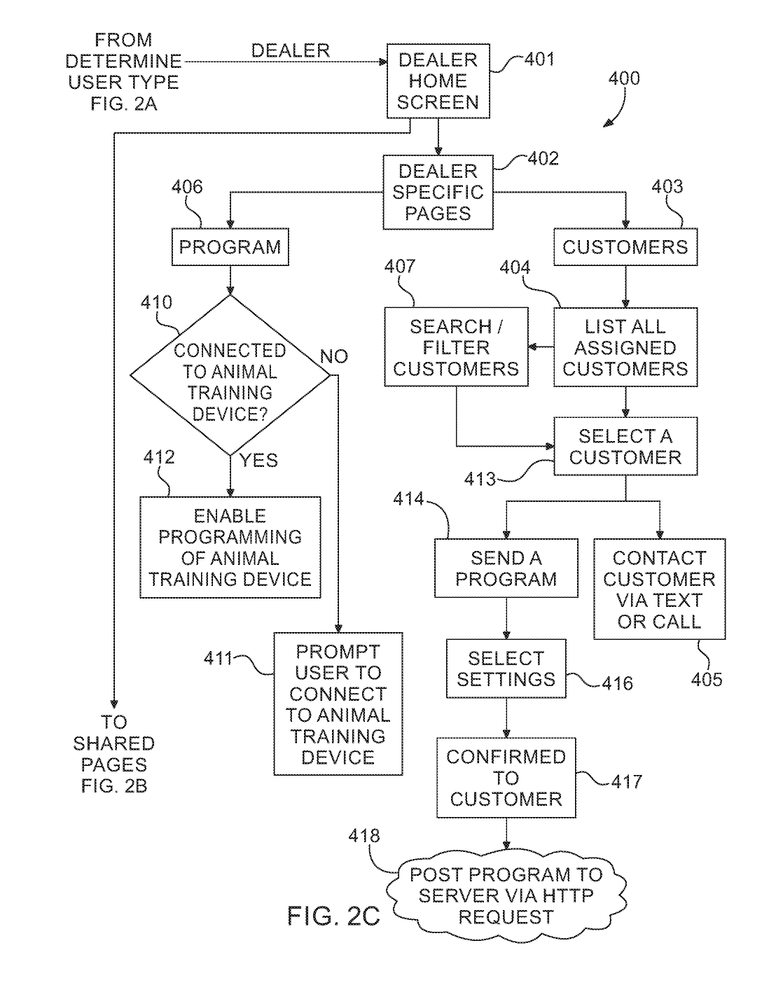

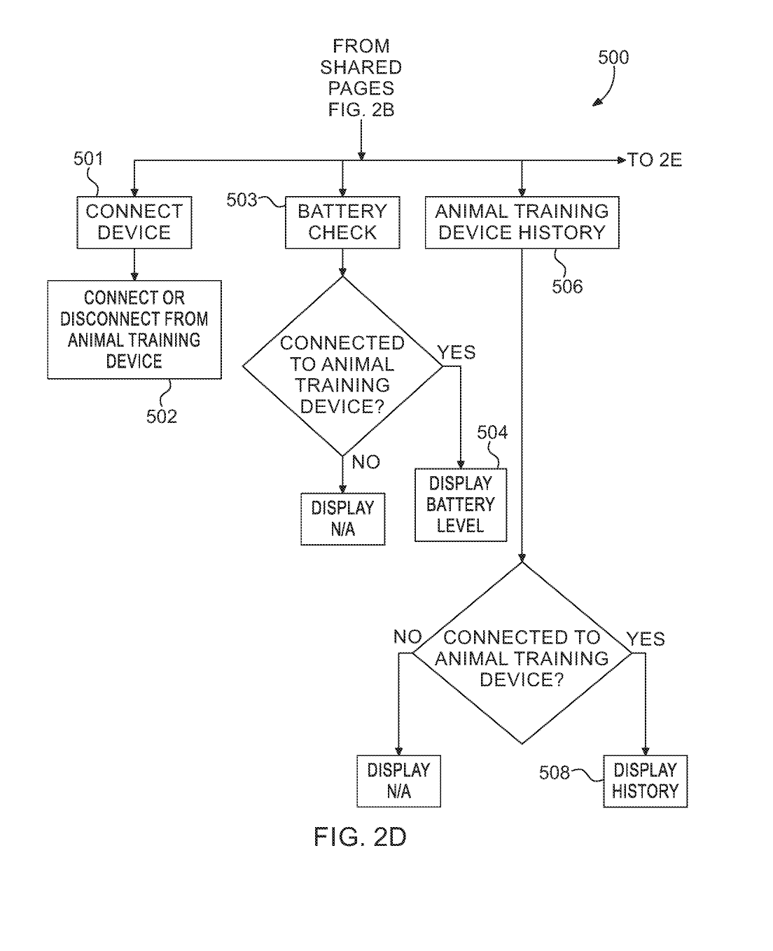

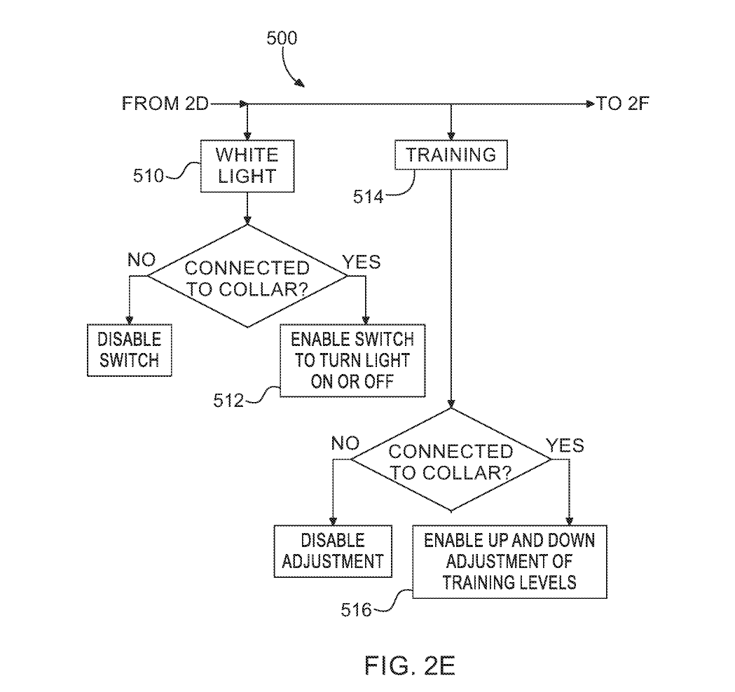

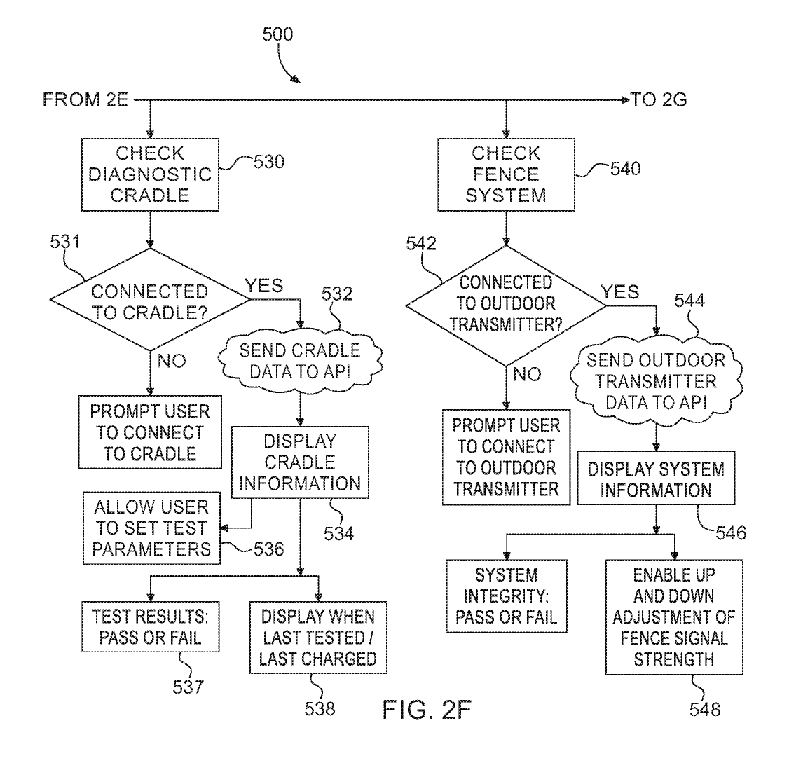

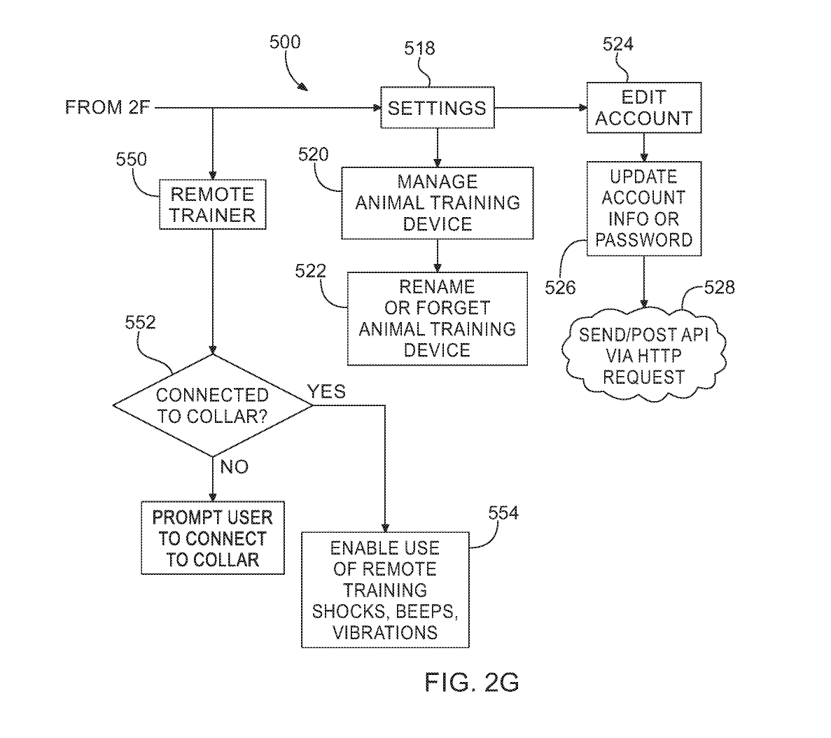

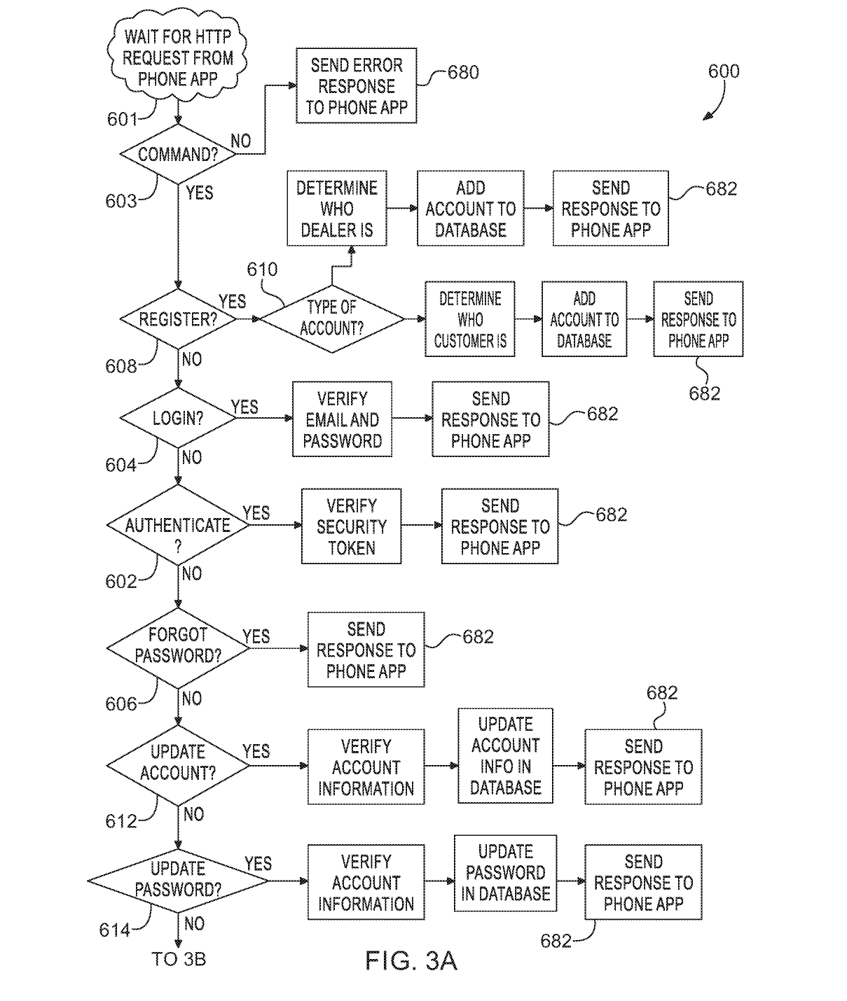

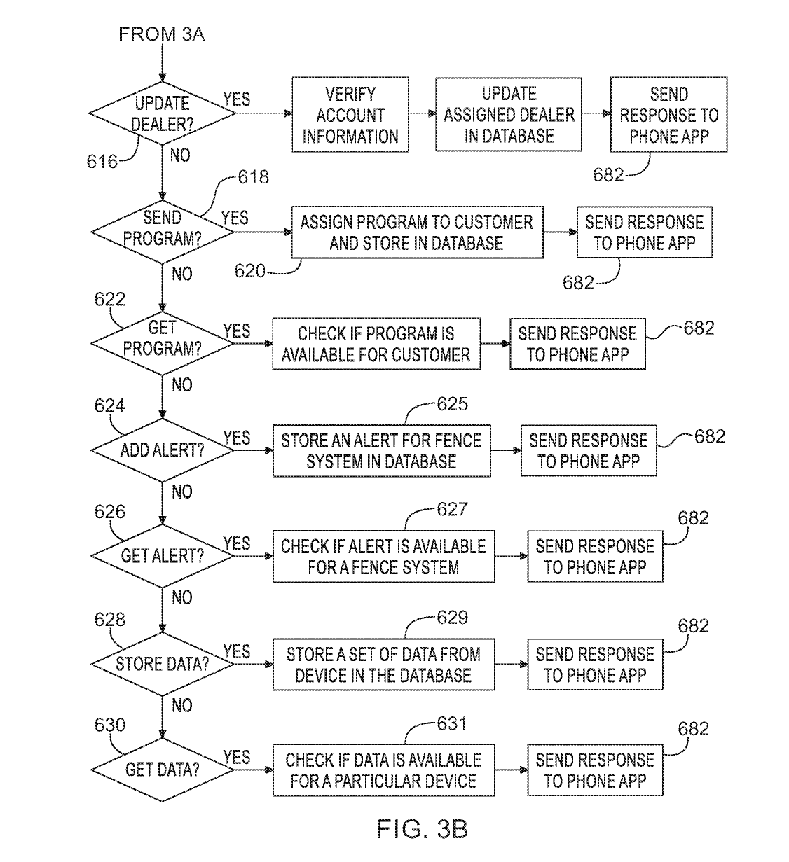

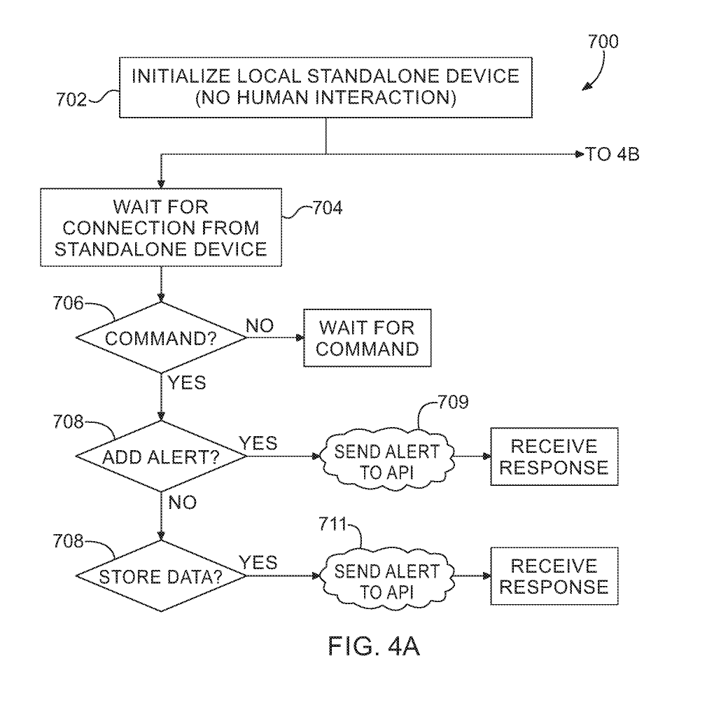

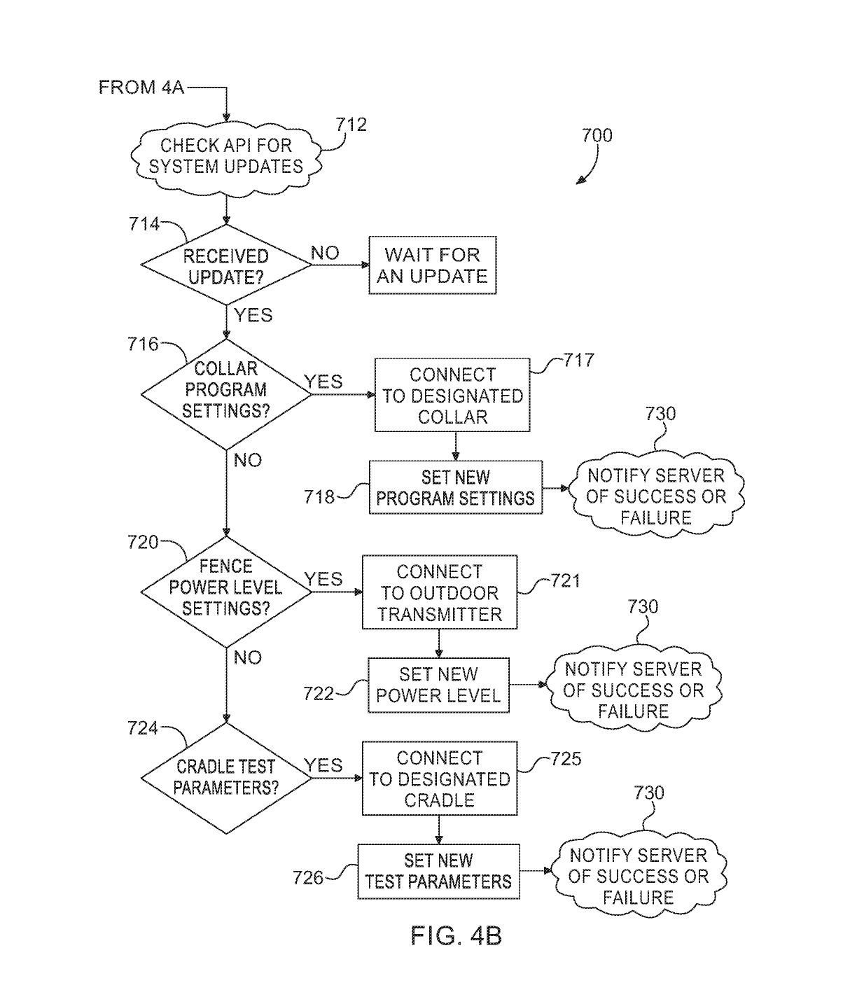

Operation of the system 100 may be understood with reference to an exemplary method in accordance with the present invention provided in the flowcharts of FIGS. 2A-3B which may be performed by an app. As explained below, the steps illustrated in FIGS. 2A, 2D-2G may be performed on either the dealer device 102 or customer device 122, while the steps of FIG. 2B are performed only on the customer device 122, and the steps of FIG. 2C are performed only on the dealer device 102. Steps performed on the standalone unit 124 may be performed as shown on FIGS. 4A-4B.

Turning to FIG. 2A, an initialization block 200 to “initialize an app” 201 to run the dealer device 102 and customer device 122 is illustrated in which the initialization block 200 performs the steps required to login a user (customer or a dealer). Among the functions illustrated in the initialization block 200 are authentication via a token 202 or login via a password 204. Steps are provided, as shown, to address the situation where a user may have forgotten their password 206 or is registering 208 for the first time. In the case of authentication by a token, the method may send a request to the server 106 to authenticate the token 207. The system may check for an alert from an animal training device 203 to display an alert to the user 205. Once the user is authenticated/logged in, the initialization block 200 performs the step “Determine User Type” 210 to ascertain whether the user is a dealer or a customer. If the user is a customer, the method continues with customer specific steps 300 as illustrated in FIG. 2B, and if the user is a dealer, the method continues with dealer specific steps 400 as illustrated in FIG. 2C.

Continuing with FIG. 2B, the exemplary method of the present invention can display a “Customer Home Screen” 301 on the customer device 122, which can provide the customer the option of selecting “Customer Specific Pages” 302. In a “Service” option 303, the method can “Display Local Dealer Information” 304 to the customer and provide contact information so the customer can “Contact Dealer Via Text Or Call” 305. As an additional option, the method can provide a “Program” option 306 to the customer on the API. To do so a “Query API Via HTTP Request” 307 may be sent to the server 106 to determine “Is Program Available” 308. If the program is not available for loading onto the animal training device 130, a button associated with the program option 306 may be disabled at step 309. If a program is available for uploading to the animal training device 130, the method may first determine if the customer device 122 is “Connected to Animal Training Device” 310. If the customer device 122 is not connected to the animal training device 130, the customer is prompted to do so, step 311. Once the customer device 122 is connected to the animal training device 130, programming information may be wirelessly transmitted to the animal training device 130 from the customer device 122 at step 312.

Continuing next with the dealer specific steps 400 as illustrated in FIG. 2C, the exemplary method of the present invention can display a “Dealer Home Screen” 401 on the dealer device 102, which can provide the dealer with the option of selecting “Dealer Specific Pages” 402. For the situations in which the dealer is on-site and in wireless communication range with the animal training device 130, the method can provide a “Program” option 406 to the dealer. If a program is available for uploading to the animal training device 130, the method may first determine if the dealer device 102 is “Connected to Animal Training Device” 410. If the dealer device 102 is not connected to the animal training device 130, the dealer is prompted to do so, step 411. Once the dealer device 102 is connected to the animal training device 130, programming information may be wirelessly transmitted to the animal training device 130 from the dealer device 102 at step 412 to “Enable Programming of Animal Training Device.”

In addition, a “Customers” option 403 may be presented to the dealer from which the dealer may “List All Assigned Customers” 404 associated with the particular dealer, and “Search/Filter Customers” 407 so the dealer can “Select a Customer” 413. Once a particular customer is selected, the method provides an option to allow the dealer to “Contact Customer via Text or Call” 405. Alternatively, once the customer is selected the dealer may “Send a Program” 414 by selecting the desired settings 416. However, a final confirmation to make sure that the program is being sent to the correct customer may be performed at step 417 after which the method can proceed to “Post Program To Server Via HTTP Request” 418. The dealer home screen 401, like the customer home screen 301, can present pages which are commonly accessed by both the dealer and customer, the “Shared Pages” step 350, as shown on FIG. 2B. The exemplary method steps 500 associated with the shared Pages available to both the dealer and customer are collectively shown at FIGS. 2D-2G.

Considering FIGS. 2D-2G, the dealer or customer may select a particular animal training device 130 at step 501 for wireless connection to their respective dealer device 102 or customer device 122. After the appropriate animal training device 130 is selected at step 501, the customer or dealer can connect or disconnect from the device 130 at step 502. As an added functionality, the dealer or customer can perform a “Battery Check” 503 from their respective device 102, 122, which will “Display Battery Level” 504 provided that the device 102, 122 is wirelessly connected to the animal training device 130. In addition, the dealer or customer can check the “Animal Training Device History” 506 and “Display the History” 508 if “Connected To the Animal Training Device.” Likewise, it may be useful to locate the animal in the dark by activating a light provided on the animal stimulus receiver 110, in which case the dealer or customer can “Enable Switch to Turn Light On or Off” 512 in a “White Light” step 510 of the API, FIG. 2E. Still further, the dealer or customer can access a “Training” 514 functionality of the method. Oftentimes, it may be desirable, especially as an animal first learns behaviors from the system 100, to adjust the stimulus provided to the animal, for example at a step by which the dealer or customer can “Enable Up and Down Adjustment of Training Levels” 516.

The method 500 further permits the dealer or customer to interact with the cradle 152 and “Check Diagnostic Cradle” 530. After confirming that the dealer's or customer's respective device 102, 122 is “Connected to Cradle” 531 the method 500 can “Send Cradle Data to API” 532 and “Display Cradle Information” 534 to the dealer or customer, such as allowing the dealer or customer to “Set Test Parameters” 536 review test results 537, and display when the cradle was last charged and tested 538. Similarly, the dealer or customer can check the performance of the fence system (i.e. buried antenna wire) associated the outdoor transmitter 142. Beginning at step 540 to “Check Fence System”, the method 500 may first determine if the dealer or customer device 102, 122 is connected to the outdoor transmitter 142. If the respective device 102, 122 is connected, the method 500 can “Send Outdoor Transmitter Data to API” 544 and “Display System Information” 546 on the dealer or customer device 102, 122, such as “System Integrity” or can “Enable Up and Down Adjustment of Fence Signal Strength” 548. Additionally, as shown in FIG. 2G, a “Remote Trainer” 550 portion of the method 500 can allow the dealer or customer to directly train the animal through interaction of the dealer or customer device 102, 122 with the animal stimulus receiver 110. For instance, after confirming that the dealer or customer device 102, 122 is “Connected to Collar” 552, the dealer or customer can “Enable Use of Remote Training Shocks, Beeps, Vibrations” 554 and so forth. The dealer or customer device 102, 122 may optionally store the number of times step 554 is activated for future analysis, and in the case of the customer device 122 for communication to the dealer device 102 via the server 106.

Still further, wireless communication between either the dealer device 102 or customer device 122 and the animal training device 130 can allow for various “Settings” 518 to be adjusted, such as, for example “Manage Animal Training Device” 520, “Rename or Forget Animal Training Device” 522, “Edit Account” 524, “Update Account Info or Password” 526, all of which can be sent to the server 106 via a “Send/Post API via HTTP Request” 528.

As already discussed, the method includes several steps which communicate with the server 106, such as steps 207, 307, 418, 528; a more detailed description of exemplary steps 600 performed on the server 106 is illustrated at FIGS. 3A-3B. The method may begin with the server waiting for a request from the dealer or customer device app, step 601. Once a command is received, step 603, if it is valid the method continues, otherwise the server 106 sends an error response to the dealer or customer device 102, 122, step 680. It should be noted, that should any errors result in any of the remaining steps of the method, in error may be sent as per step 680. Alternatively, successful completion of any of the steps can be accompanied by sending a response at step 682 to an app running on the dealer or customer device 102, 122.

Steps 602-610 performed on the server 106 may correlate to steps 202-210 (FIG. 2A) performed on the dealer or customer device 102, 122. Specifically, the server 106 can execute a step of determining if the particular user needs to be registered, step 608, after which the type of account 610 can be identified as either customer or dealer. Registration of the customer can operate to “Determine Who Dealer Is” for the particular customer, “Add Account to Database” for the customer, and “Send Response” to the customer device 122. Similarly, registration of a dealer can operate to “Determine Who Customer Is”, “Add Account to Database”, and “Send Response” to the dealer device 102. If registration of the account is not required, the method can continue with logging in the user, step 604, in which the method can “Verify Email and Password” and then “Send Response” to the dealer or customer device 102, 122 as appropriate. Alternatively, the method can authenticate 602 by verifying a security or authentication token. In addition, the method can determine if the user has forgotten his or her password 606 and send an appropriate communication to the customer device 122 to permit password reset. Still further, the server 106 can execute steps to update an account 612 or password 614 including steps to “Verify Account Information” and “Update Account Info” or “Update Password in Database”, corresponding to steps 524-528 previously discussed in connection with FIG. 2G. In addition, in the case, for example, where the customer moves out of a particular dealer area, it may be necessary to update the dealer associated with the customer. In this regard, the method may include a step to “Update Dealer” 616 which also includes the steps to “Verify Account Information”, “Update Assigned Dealer in Database”, and send confirmatory response to the customer device 122, FIG. 3B.

As to the step of posting or sending the program information from the dealer device 102 to the server 106, the server side of this process can include step 618 which determines that a program has been sent to the server 106, after which the server can “Assign Program to Customer and Store in Database” 620, and send a confirmatory response to the dealer device 102. The server 106 may also received a “Get Program” request 622 from the customer device 122, in which case the server 106 can “check if Program is Available for Customer” and send a confirmatory response to the customer device 122.

Additional functionality that may be provided on the server 106 includes the handling of alerts. For example, the system can “Add an Alert” 624 to “Store an Alert in Database” 625 or “Get an Alert” 626 to “Check if Alert is Available” 627. The store in of data for loading on an animal training device 130 on the server 106 may be accomplished at step 628 to determine if the system should “Store Data”, in which case the server 106 functions to “Store a Set of Data” from one or more of the dealer and customer device 102, 122 and a server database, step 629. Similarly, a step to “Get Data” 630 may be provided to “Check if Data is Available” 631 for transmission to one or more of the dealer and customer device 102, 122.

In addition, the methods of the present invention provide for the operation of standalone units 122 that may operate to transmit and receive information from the animal training device 130 without the need for customer interaction. For example, in the exemplary method steps 700 illustrated on FIGS. 4A-4B, the method can “initialize Local Standalone Device” 702 after which, the system can “Wait for Connection from Standalone Device” 704, FIG. 4A. Once connected and after receiving a command 706, the standalone device 124 can “Add an Alert” 708 or “Store Data” 710 by sending an alert to the API 709, 711. In addition, the standalone unit 124 can check on the server 106 for system updates at step 712, FIG. 4B. If an update is received at step 714, in the case of programming of the animal stimulus receiver 110 at step 716 the method can connect to a designated collar at step 717 and set new program settings on the animal stimulus receiver 110 at step 718. If the received update at step 714 relates to the outdoor transmitter 142 as determined at step 720, the standalone unit 124 can connect to the outdoor transmitter 142 at step 721 and can set a new power level for the outdoor transmitter 142 at step 722. Similarly, if the received update at step 714 relates to the cradle 152 as determined at step 724, the standalone unit 124 can connect to the cradle 152 at step 725 and consent new test parameters for the cradle 152 at step 726. After each of steps 718, 722, 726, the standalone unit can “Notify server of Success or Failure” at step 730. Consequently, the methods of FIGS. 2A-4B collectively illustrate exemplary methods by which the system of FIG. 1 can operate.

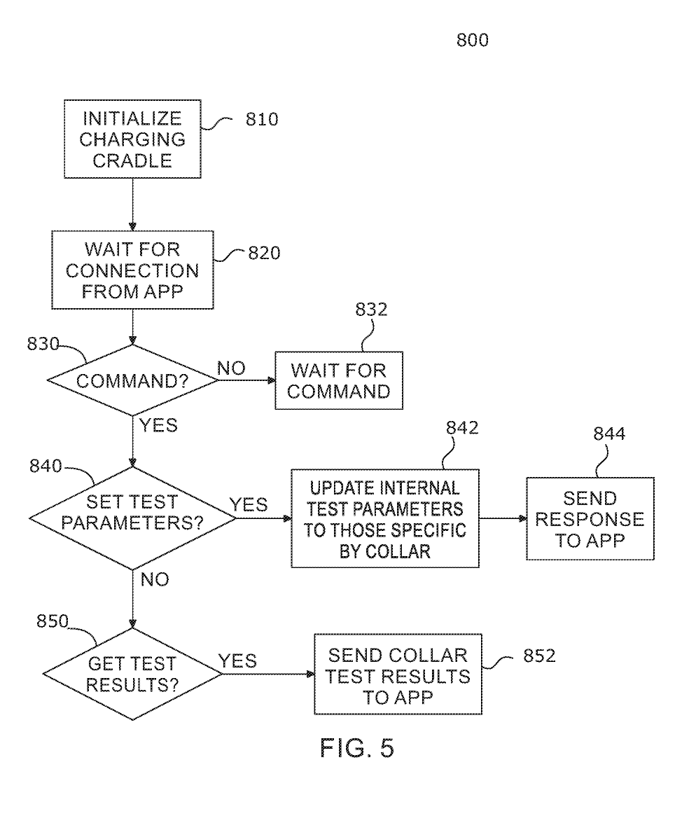

Methods of the present invention may also provide for testing of the animal stimulus transceiver 110 by the cradle 152 as illustrated in flowchart 800, FIG. 5. As a first step, the cradle is initialized 810 and waits for a connection 820 from the aforementioned app. The cradle waits for a command 832, and once a command is received 830 the cradle may set test parameters 840 on the animal stimulus transceiver 110 or get test results 850 therefrom. If test parameters are to be set, the cradle 152 can update internal test parameters of the animal stimulus receiver 842 after which a response may be sent to the app at step 844. If test results are retrieved, the results may be sent to the app at step 852.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A system for wirelessly programming and controlling an animal training system, comprising:
an animal training device, provided at the site of an animal to be trained, having a communication unit configured to permit wireless communication therewith and having a memory unit for storing program information therein;
a server for receiving and transmitting the program information for programming the animal training device;
a dealer device disposed in communication with the server for transmitting the program information thereto; and
a local communication device disposed in communication with the server for receiving the program information therefrom, the local communication device configured to wirelessly communicate with, and deliver the program information to, the memory unit of the animal training device.

2. The system of claim 1, wherein the animal training device is one or more of an animal stimulus receiver, an indoor transmitter, an outdoor transmitter, and a stimulus receiver cradle.

3. The system of claim 1, wherein the animal training device is an animal stimulus receiver configured to deliver a stimulus to an animal.

4. The system of claim 3, wherein the animal stimulus receiver is an animal collar.

5. The system of claim 1, wherein the communication unit of the animal training device communicates at a frequency between 2 and 6 GHz.

6. The system of claim 1, wherein the dealer device is configured to wirelessly communicate with, and deliver the program information to, the memory unit of the animal training device.

7. The system of claim 1, wherein the local communication device comprises one or more of a customer device and a standalone unit.

8. The system of claim 7, wherein the customer device comprises a portable electronic device.

9. The system of claim 8, wherein the customer device comprises a cell phone.

10. The system of claim 1, wherein the dealer device comprises a portable electronic device.

11. The system of claim 1, wherein the dealer device comprises a cell phone.

12. The system of claim 1, wherein the server is a cloud-based server.

13. The system of claim 1, wherein the memory of the animal training device is configured to store historical information on the operation of the animal training device.

14. The system of claim 13, wherein the historical information includes one or more of stimulus durations, number of warnings issued to the animal, and stimulus magnitudes, number of stimuli provided in a selected time interval.

15. The system of claim 1, wherein the communication unit includes a transceiver.

16. The system of claim 15, wherein the transceiver is operable to transmit the historical information to the server via one or more of the local communication device and the dealer device.

17. A method for wirelessly programming and controlling an animal training device, comprising:
providing a server for receiving and transmitting program information for programming an animal training device;
uploading the programming information to the server from a dealer device disposed in communication therewith;
transmitting the program information from the server to a local communication device disposed in communication therewith; and
wirelessly transmitting the program information from one of the dealer device and local communication device to the animal training device to load the program information in the animal training device.

18. The method of claim 17, wherein the step of wirelessly transmitting the program information comprises transmitting the program information from the local communication device to the animal training device.

19. The method of claim 17, comprising sending an alert to the local communication device to indicate that the program information is available for transmission to the animal training device.

20. The method of claim 19, wherein the alert is sent from the dealer device to the local communication device via the server.

21. The method of claim 17, wherein the step of uploading the program information comprises identifying a selected customer from a database of customers to associate the program information with the selected customer.

22. The method of claim 17, wherein the local communication device queries the server to determine if the program information is available for the local communication device.

23. The method of claim 17, comprising the step of determining if the local communication device is wirelessly connected to the animal training device.

24. The method of claim 17, wherein the animal training device includes a stimulus unit configured to deliver a stimulus to an animal.

25. The method of claim 24, wherein the program information contains data for specifying parameters for delivering the stimulus by the stimulus unit.

26. The method of claim 25, wherein the parameters include one or more of the stimulus duration, warning time, and stimulus magnitude.

27. The method of claim 17, wherein the step of wirelessly transmitting the program information comprises transmitting the program information at a frequency between 2 and 6 GHz.

28. The method of claim 17, wherein one or more of the dealer device and the local communication device comprises a portable electronic device.

29. The method of claim 17, wherein one or more of the dealer device and the local communication device is operable to perform one or more of: 1) connect to the animal training device, 2) check the battery level of the animal training device, 3) check historical data on the operation of the animal training device, 4) activate a light on the animal training device, and 5) initialize animal training.

30. The method of claim 17, wherein one or more of the dealer device and the selected local communication device comprises a cell phone.
